(19) United States
(12) Patent Application Publication
(10) Pub. No.: US 2026/0063878 A1
(43) Pub. Date: Mar. 5, 2026

(54) ZOOM LENS AND IMAGE PICKUP APPARATUS

(71) Applicant: CANON KABUSHIKI KAISHA, Tokyo (JP)

(72) Inventors: Naotoshi OGAWA, Tochigi (JP); Kazufumi GOTO, Tochigi (JP); Yusuke KUROSU, Tochigi (JP)

(21) Appl. No.: 19/299,479

(22) Filed: Aug. 14, 2025

(30) Foreign Application Priority Data
Sep. 5, 2024 (JP) 2024-153102

(51) Int. Cl. G02B 13/00; G02B 15/14

(52) U.S. Cl. CPC G02B 13/009; G02B 13/0045; G02B 15/145125

(57) ABSTRACT

A zoom lens includes a first lens unit with positive refractive power that does not move for zooming, an intermediate group including three or more lens units that move for zooming, and a rear lens unit with positive refractive power that does not move for zooming. The intermediate group includes a first intermediate negative lens unit that includes a single lens unit or two or more partial lens units and having negative refractive power that moves toward the image side during zooming from a wide-angle end to a telephoto end, a second intermediate negative lens unit having negative refractive power that moves during zooming, and an intermediate positive lens unit having positive refractive power that moves during zooming. At least one of lens units having negative refractive power disposed in the intermediate group moves in a convex locus toward the object side during zooming. Predetermined inequalities are satisfied.

### BACKGROUND

### Field of the Technology

The aspect of the disclosure relates to one or more embodiments of a zoom lens and an image pickup apparatus.

### Description of the Related Art

Zoom lenses are demanded to have a wide angle of view, a high zoom ratio, and a reduced size and weight. The zoom lens disclosed in Japanese Patent Application Laid-Open No. 2016-004076 includes, in order from the object side to the image order, a first lens unit with positive refractive power that does not move for zooming, a second lens unit with negative refractive power that moves for zooming, a third lens unit with negative refractive power that moves for zooming, and a rear lens unit with positive refractive power that does not move for zooming.

### SUMMARY

One or more embodiments of a zoom lens according to one or more aspects of the disclosure may include, in order from an object side to an image side, a first lens unit with positive refractive power that does not move for zooming, an intermediate group including three or more lens units that move for zooming, and a rear lens unit with positive refractive power that does not move for zooming. Each distance between adjacent lens units changes during zooming. The intermediate group includes, in order from the object side to the image side, a first intermediate negative lens unit that includes a single lens unit or two or more partial lens units and having negative refractive power as a whole that moves monotonically toward the image side during zooming from a wide-angle end to a telephoto end, a second intermediate negative lens unit having negative refractive power that moves during zooming, and an intermediate positive lens unit having positive refractive power that moves during zooming. At least one of lens units having negative refractive power disposed in the intermediate group moves in a convex locus toward the object side during zooming from the wide-angle end to the telephoto end. The following inequalities are satisfied:

$$4. \leq ft / f 1 \leq 800$$

$$- 9. 0 \leq f 1 / fv \leq - 5.50$$

where fl is a focal length of the first lens unit, fv is a focal length of the first intermediate negative lens unit, and ft is a focal length of the zoom lens at the telephoto end. One or more image pickup apparatuses may include one or more zoom lenses in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a zoom lens according to Example 1.

FIGS. 2A, 2B, and 2C are aberration diagrams of the zoom lens according to Example 1.

FIG. 3 is a sectional view of a zoom lens according to Example 2.

FIGS. 4A, 4B, and 4C are aberration diagrams of the zoom lens according to Example 2.

FIG. 5 is a sectional view of a zoom lens according to Example 3.

FIGS. 6A, 6B, and 6C are aberration diagrams of the zoom lens according to Example 3.

FIG. 7 is a sectional view of a zoom lens according to Example 4.

FIGS. 8A, 8B, and 8C are aberration diagrams of the zoom lens according to Example 4.

FIG. 9 is a sectional view of a zoom lens according to Example 5.

FIGS. 10A, 10B, and 10C are aberration diagrams of the zoom lens according to Example 5.

FIG. 11 is a sectional view of a zoom lens according to Example 6.

FIGS. 12A, 12B, and 12C are aberration diagrams of the zoom lens according to Example 6.

FIG. 13 illustrates the configuration of the image pickup apparatus.

### DESCRIPTION OF THE EMBODIMENTS

Referring now to the accompanying drawings, a description will be given of examples according to the disclosure.

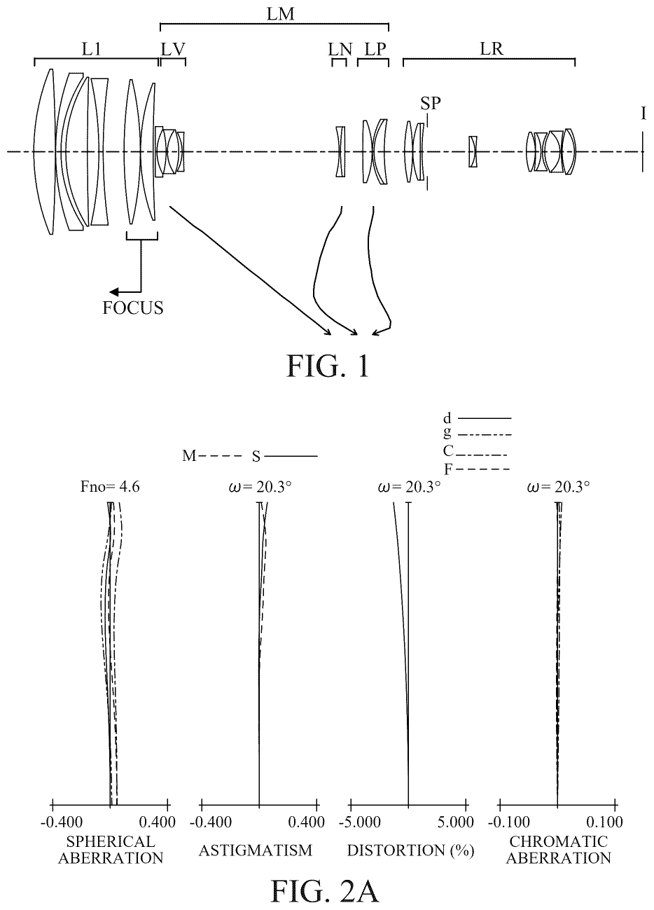

Prior to a detailed description according to Examples 1 to 6, the matters common to each example will be described with reference to FIG. 1 illustrating a zoom lens according to Example 1. The zoom lens according to each example is used for various image pickup apparatuses such as broadcasting cameras, cinema cameras, video cameras, surveillance cameras, digital still cameras, and film-based cameras.

FIG. 1 illustrates the configuration of the zoom lens according to Example 1 at a wide-angle end in an in-focus state on an object at infinity (hereinafter referred to as “in an in-focus state at infinity”).

In the zoom lens, a lens unit is a group of one or more lenses that may or may not integrally move during zooming (magnification variation) between the wide-angle end and a telephoto end. That is, each distance between adjacent lens units changes during zooming. The lens unit may include an aperture stop (diaphragm). The wide-angle end and the telephoto end respectively indicate zoom states of the maximum angle of view (shortest focal length) and the minimum angle of view (longest focal length) in a case where the lens unit that moves during zooming is located at both ends of a mechanically or controllably movable range on the optical axis.

The zoom lens according to each example includes, in order from the object side to the image side, a first lens unit L1, an intermediate group LM including three or more lens units, and a rear lens unit (relay lens unit) LR as a final lens unit closest to the image plane. The rear lens unit LR includes an aperture stop SP.

The first lens unit L1 does not move (is stationary) for zooming and has positive refractive power.

The intermediate group LM includes, in order from the object side to the image side, at least a first intermediate negative lens unit LV having negative refractive power, a second intermediate negative lens unit LN having negative refractive power, and an intermediate positive lens unit LP having positive refractive power. The intermediate positive lens unit LP and the second intermediate negative lens unit LN are arranged in this order consecutively from the object side in the intermediate group LM. FIG. 1 illustrates a moving locus (or trajectory) of each lens unit included in the intermediate group LM during zooming from the wide-angle end to the telephoto end by an arrow.

The first intermediate negative lens unit LV moves monotonically (i.e., non-reciprocally) toward the image side during zooming from the wide-angle end to the telephoto end. The first intermediate negative lens unit LV may include a single lens unit, or two or more partial lens units that move independently of each other during zooming as illustrated in Example 5, and have negative refractive power as a whole.

The second intermediate negative lens unit LN moves non-monotonically (reciprocally) to trace a convex trajectory toward the object side during zooming. The intermediate positive lens unit LP moves to trace a convex trajectory toward the object side during zooming from the wide-angle end to the telephoto end, and then moves non-monotonically to trace a convex trajectory toward the image side during zooming.

The intermediate group LM may include another lens unit that moves during zooming other than the first intermediate negative lens unit LV, the second intermediate negative lens unit LN, and the intermediate positive lens unit LP. In this case, “arranged in order from the object side to the image side” indicates the arrangement in the order excluding the other lens unit.

The rear lens unit LR does not move during zooming and has positive refractive power. The aperture stop SP does not move during zooming. I represents an image plane. The imaging surface (light receiving surface) of the image sensor and the film surface (photosensitive surface) of the silver film are disposed on the image plane I. A glass block such as a prism or an optical filter may be disposed between the rear lens unit LR and the image plane I.

For focusing, a part of the first lens unit L1 (two lenses on the image side) moves. In FIG. 1, a moving direction of a part of the first lens unit L1 during focusing from infinity to a close distance is indicated by an arrow labeled with FOCUS. However, the entire first lens unit L1 may move during focusing.

In the zoom lens according to each example (or each numerical example described later), the following inequalities may be satisfied:

$$4. \leq ft / f 1 \leq 800 \qquad ( 1 )$$

$$- 9. 0 \leq f 1 / fv \leq - 5.50 \qquad ( 2 )$$

where fl is a focal length of the first lens unit L1, fv is a focal length of the first intermediate negative lens unit LV, and ft is a focal length of the zoom lens at the telephoto end.

Inequality (1) defines a condition for achieving a zoom lens that is beneficial in terms of a wide angle of view, a high zoom ratio, a reduced size and weight, and high optical performance. In a case where ft/fl becomes higher than the upper limit of inequality (1), the enlargement magnification of the first lens unit L1 at the telephoto end increases, a variety of aberrations at the telephoto end increase, and optical performance degrades. In a case where ft/fl becomes lower than the lower limit of inequality (1), the focal length of the first lens unit L1 increases, and the lateral magnification of the first intermediate negative lens unit LV at the wide-angle end reduces. As a result, the moving amount of the first intermediate negative lens unit LV increases, the entrance pupil of the zoom lens is much closer to the image plane at the wide-angle end, and thus the diameter of the first lens unit L1 and finally the size of the zoom lens increase.

The lower limit of inequality (1) may be set to 4.50, 4.70, or 4.95. The upper limit of inequality (1) may be set to 7.50, 7.30, or 7.15.

Inequality (2) defines a condition for achieving a zoom lens that is beneficial in terms of a high zoom ratio, a reduced size and weight, and high optical performance. In a case where fl/fv becomes higher than the upper limit of inequality (2), the refractive power of the first intermediate negative lens unit LV increases, the aberrational fluctuation during zooming increases, and the optical performance deteriorates. In a case where fl/fv becomes lower than the lower limit of inequality (2), the refractive power of the first intermediate negative lens unit LV reduces, a moving amount of the first intermediate negative lens unit LV during zooming increases, the entrance pupil of the zoom lens is much closer to the image plane at the wide-angle end, and the diameter of the first lens unit L1 and finally the size of the zoom lens increase. In addition, a large moving amount of the first intermediate negative lens unit LV cannot secure a moving amount of the first lens unit L1 to achieve a high zoom ratio.

The lower limit of inequality (2) may be set to −8.50, −8.00, or −7.80. The upper limit of inequality (2) may be set to −6.00, −6.50, or −6.80.

The zoom lens according to each example may satisfy at least one of the following inequalities (3) to (11).

The zoom lens according to each example may satisfy the following inequality:

$$0.6 \leq ( f 1 + ok 1 ) / f 1 \leq 0.95 \qquad ( 3 )$$

where ok1 is the distance on the optical axis from a lens surface closest to the image plane of the first lens unit L1 to an image-side principal point of the first lens unit L1 in the in-focus state at infinity.

Inequality (3) defines a condition for achieving a zoom lens that is beneficial in terms of a wide angle of view, a high zoom ratio, a reduced size and weight, and high optical performance. In a case where (fl+ok1)/fl becomes higher than the upper limit of inequality (3), the image-side principal point of the first lens unit L1 is much closer to the image plane. As a result, the lateral magnification of the first intermediate negative lens unit LV at the wide-angle end reduces, a moving amount of the first intermediate negative lens unit LV increases, and the size of the zoom lens increases. In addition, the focal length of the first lens unit L1 reduces, and a variety of aberrations increase at the telephoto end. In a case where (fl+ok1)/fl becomes lower than the lower limit of inequality (3), the image-side principal point of the first lens unit L1 is much closer to the image plane. As a result, the entrance pupil at the wide-angle end is located much closer to the image plane, and the diameter of the first lens unit L1 and finally the size of the zoom lens increase. In addition, the focal length of the first lens unit L1 increases, the lateral magnification of the first intermediate negative lens unit LV at the wide-angle end reduces, a moving amount of the first intermediate negative lens unit LV increases, and the size of the zoom lens increases.

The lower limit of inequality (3) may be set to 0.65, 0.70, or 0.73. The upper limit of inequality (3) may be set to 0.93, 0.90 or 0.89.

The zoom lens according to each example may satisfy the following inequality:

$$- 0.35 \leq β vw \leq - 0 \text{.15} \qquad ( 4 )$$

where βvw is a lateral magnification of the first intermediate negative lens unit LV at the wide-angle end.

Inequality (4) defines a condition for achieving a zoom lens that is beneficial in terms of a wide angle of view, a high zoom ratio, a reduced size and weight, and high optical performance. In a case where βvw becomes higher than the upper limit of inequality (4), the divergence of a light beam from the first intermediate negative lens unit LV increases, and the fluctuation of various aberrations during zooming increases. In a case where βvw becomes lower than the lower limit of inequality (4), the lateral magnification of the first intermediate negative lens unit LV reduces, a moving amount of the first intermediate negative lens unit LV increases, and the size of the zoom lens increases.

The lower limit of inequality (4) may be set to −0.33, −0.30 or −0.27. The upper limit of inequality (4) may be set to −0.17, −0.19 or −0.20.

The following inequality may be satisfied:

$$- 1000.00 \leq β vt \leq - 2.00 \qquad ( 5 )$$

where βvw is a lateral magnification of the first intermediate negative lens unit LV at the telephoto end.

Inequality (5) defines a condition for achieving a zoom lens that is beneficial in terms of a wide angle of view, a high zoom ratio, a reduced size and weight, and high optical performance. In a case where βvt becomes higher than the upper limit of inequality (5), the magnification at the telephoto end reduces, and a zoom ratio reduces. Furthermore, in order to increase the zoom ratio, the magnification of the second intermediate negative lens unit LN and the intermediate positive lens unit LP at the telephoto end increases, and the size of the zoom lens increases. In a case where βvt becomes lower than the lower limit of inequality (5), the image-point change of the first intermediate negative lens unit LV at the telephoto side increases, moving amounts of the second intermediate negative lens unit LN and the intermediate positive lens unit LP for image point correction increase, and the size of the zoom lens unit increases.

The lower limit of inequality (5) may be set to −985.00, −100.00, or −20.00. The upper limit of inequality (5) may be set to −3.00, −4.00, or −4.40.

In the zoom lens according to each example, the following inequality may be satisfied:

$$6. \leq ft / \vert mv \vert \leq 15. \qquad ( 6 )$$

where mv is a change amount (moving amount) between a position at the wide-angle end and a position at the telephoto end of a single lens unit in the first intermediate negative lens unit LV, or a change amount between a position at the wide-angle end and a position at the telephoto end of a partial lens unit among two or more partial lens units, which has the largest change amount between the position at the wide-angle end and the position at the telephoto end.

The change in the position of a lens unit is positive in a case where the lens unit is located closer to the image plane at the telephoto end than at the wide-angle end. Inequality (6) defines a proper relationship between the change in the position of the first intermediate negative lens unit LV during zooming and the focal length of the zoom lens at the telephoto end. Satisfying inequality (6) can provide an effect of suppressing a moving amount of the first intermediate negative lens unit LV or fluctuation of various aberrations during zooming.

The lower limit of inequality (6) may be set to 6.50, 7.00, or 7.20. The upper limit of inequality (6) may be set to 14.00, 13.00, or 12.60.

The following inequality may be satisfied:

$$1.5 \leq f 1 / fp \leq 5. \qquad ( 7 )$$

where fp is a focal length of the intermediate positive lens unit LP.

Inequality (7) defines a proper relationship between the focal lengths of the first lens unit L1 and the intermediate positive lens unit LP. Satisfying inequality (7) can provide an effect of suppressing a moving amount of the intermediate positive lens unit LP or fluctuations of a variety of aberrations during zooming.

The lower limit of inequality (7) may be set to 2.00, 2.30, or 2.50. The upper limit of inequality (7) may be set to 4.50, 4.00, or 3.50.

The following inequality may be satisfied:

$$- 4.00 \leq f 1 / fn \leq - 1. \qquad ( 8 )$$

where fn is a focal length of the second intermediate negative lens unit LN.

Inequality (8) defines a proper relationship between the focal lengths of the first lens unit L1 and the second intermediate negative lens unit LN. Satisfying inequality (8) can provide an effect of suppressing a moving amount of the second intermediate negative lens unit LN or fluctuations of a variety of aberrations during zooming.

The lower limit of inequality (8) may be set to −3.50, −3.20, or −3.00. The upper limit of inequality (8) may be set to −1.10, −1.15, or −1.20.

In the zoom lens according to each example, the following inequality may be satisfied:

$$0. \leq θ gF 1 N - θ gF 1 P \leq 0.030 \qquad ( 9 )$$

where θgF1P is an average value of partial dispersion ratios for the g-line and F-line of all positive lenses included in the first lens unit L1, and θgF1N is an average value of partial dispersion ratios for the g-line and F-line of all negative lenses included in the first lens unit L1.

The partial dispersion ratio θgF for the g-line and F-line is defined as:

$$θ gF = ( Ng - NF ) / ( NF - NC )$$

where NF, Nd and Ng are refractive indices for the F-line (wavelength 486.1 nm), C-line (wavelength 656.3 nm) and g-line (435.8 nm), respectively.

Inequality (9) defines a proper achromatic condition for the first lens unit L1. Satisfying inequality (9) can provide an effect of suppressing longitudinal chromatic aberration at the telephoto end or the size of the first lens unit L1.

The lower limit of inequality (9) may be set to 0.004, 0.008, or 0.010. The upper limit of inequality (9) may be set to 0.020, 0.018, or 0.015.

In the zoom lens according to each example, the following inequality may be satisfied:

$$- 0.060 \leq θ gFvN - θ gFvP \leq - 0.020 \qquad ( 10 )$$

where θgFvP is an average value of partial dispersion ratios for the g-line and F-line of all positive lenses included in the first intermediate negative lens unit LV, and θgFvN is an average value of the partial dispersion ratios for the g-line and F-line of all negative lenses included in the first intermediate negative lens unit LV.

Inequality (10) defines a proper achromatic condition for the first intermediate negative lens unit LV. Satisfying inequality (10) can provide an effect of suppressing the longitudinal chromatic aberration at the telephoto end or the fluctuation of the lateral chromatic aberration during zooming.

The lower limit of inequality (10) may be set to −0.055, −0.050, or −0.048. The upper limit of inequality (10) may be set to −0.025, −0.030, or −0.035.

The zoom lens according to each example may satisfy the following inequality:

$$80. \leq vd 1 P \leq 96. \qquad ( 11 )$$

where νd1P is an average Abbe number based on the d-line of all the positive lenses included in the first lens unit L1.

The Abbe number νd based on the d-line is defined as:

$$v d = ( Nd - 1 ) / ( NF - NC )$$

where NF, Nd and NC are refractive indices for the F-line (wavelength 486.1 nm), d-line (wavelength 587.6 nm) and C-line (wavelength 656.3 nm), respectively.

Inequality (11) defines a proper achromatic condition for the first lens unit L1. Satisfying inequality (11) can provide an effect of suppressing the longitudinal chromatic aberration at the telephoto end or a variety of aberrations at the telephoto end.

The lower limit of inequality (11) may be set to 83.00, 86.00 or 88.00. The upper limit of inequality (11) may be set to 94.00, 93.00 or 92.00.

In the zoom lens according to each example, the intermediate positive lens unit LP may move to draw a convex trajectory toward the object side and then move to draw a convex trajectory toward the image side during zooming from the wide-angle end to the telephoto end. The intermediate positive lens unit LP moving to draw a convex trajectory from the wide-angle end causes the entrance pupil on the wide-angle side to be located on the object side, which is beneficial in terms of widening the angle and reducing the size. The intermediate positive lens unit LP subsequently moving to draw a convex trajectory toward the image side can increase the zoom ratio obtained by moving the first intermediate negative lens unit LV while preventing interference between the first intermediate negative lens unit LV and the second intermediate negative lens unit LN.

A specific description will now be given of the zoom lenses according to Examples 1 to 6. After Example 6, numerical examples 1 to 6 corresponding to Examples 1 to 6, respectively, will be illustrated.

In each numerical example, a surface number i indicates the order of the optical surface counted from the object side. In surface data, r represents a radius of curvature of an i-th surface (mm), d represents a lens thickness or air gap (mm) between i-th and (i+1)-th surfaces, and nd represents an absolute refractive index at 1 atmospheric pressure for the d-line of the optical material between i-th and (i+1)-th surfaces. νd represents an Abbe number based on the d-line of an optical material between i-th and (i+1)-th surfaces, and is defined as described above. θgF is a partial dispersion ratio for the g-line and F-line of an optical material between i-th and (i+1)-th surfaces, and is defined as described above.

A half angle of view ω (°) is a value expressed by:

$$ω = arctan ( Y / fw )$$

where 2Y is a diagonal size of an image sensor in the image pickup apparatus for which the zoom lens is used, and fw is a focal length of the zoom lens at the wide-angle end.

The image height (mm) indicates the maximum image height equivalent to half Y (e.g., 5.50 mm) of the diagonal size 2Y (e.g., 11.00 mm). BF is the back focus (mm) and is a distance on the optical axis from a lens surface closest to the image plane (final surface) of the zoom lens to a paraxial image surface expressed in air equivalent length. An overall lens length (mm) is a distance on the optical axis from a lens surface closest to the object (frontmost surface) of the zoom lens to a final surface plus the back focus.

An asterisk “*” next to a surface number means that the surface has an aspherical shape. The aspherical shape is expressed by the following expression:

$$X = \frac{{H}^{2} / R}{1 + \sqrt{1 - ( 1 + k ) {( H / R )}^{2}}} + A 4 \cdot {H}^{4} + A 6 \cdot {H}^{6} + A 8 \cdot {H}^{8} + A 10 \cdot {H}^{10} + A 12 \cdot {H}^{12} + A 14 \cdot {H}^{14} + A 16 \cdot {H}^{16} + A 3 \cdot {H}^{3} + A 5 \cdot {H}^{5} + A 7 \cdot {H}^{7} + A 9 \cdot {H}^{9} + A 11 \cdot {H}^{11} + A 13 \cdot {H}^{13} + A 15 \cdot {H}^{15}$$

where X is a displacement amount from a surface vertex in the optical axis direction, H is a height from the optical axis in a direction orthogonal to the optical axis, a light traveling direction is positive, R is a paraxial radius of curvature, K is a conical constant, and A3 to A16 are aspherical coefficients.

The conical constant and aspherical coefficient “e=Z” mean “x 10+Z.”

Table 1 summarizes values of inequalities (1) to (11) in the numerical examples 1 to 6. Table 2 summarizes values of the variables included in inequalities (1) to (11) in numerical examples 1 to 6. The zoom lenses according to numerical examples 1 to 6 satisfy all of inequalities (1) to (11).

### Example 1

In a zoom lens according to Example 1 (numerical example 1) illustrated in FIG. 1, the first lens unit L1 has first to twelfth surfaces and includes two negative lenses and four positive lenses. The intermediate group LM has thirteenth to twenty-seventh surfaces. The first intermediate negative lens unit LV has thirteenth to nineteenth surfaces and includes a single negative lens whose object-side surface is aspheric, two negative lenses, and one positive lens.

The second intermediate negative lens unit LN has twentieth to twenty-second surfaces and includes a single negative lens and a single positive lens. The intermediate positive lens unit LP has twenty-third to twenty-seventh surfaces and includes a single positive lens whose object-side surface is aspheric, a single negative lens, and a single positive lens. The rear lens unit LR has twenty-eighth to forty-seventh surfaces and includes five negative lenses and seven positive lenses. The aperture stop SP is a thirty-third surface.

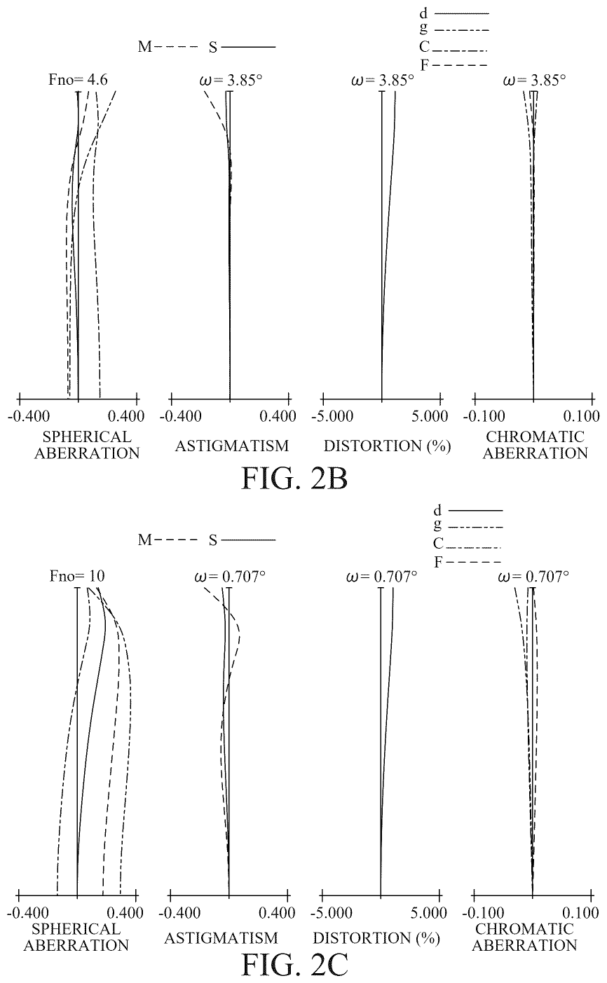

FIGS. 2A, 2B, and 2C illustrate longitudinal aberrations (spherical aberration, astigmatism, distortion, and chromatic aberration) of the zoom lens according to numerical example 1. FIGS. 2A to 2C correspond to a wide-angle end (WIDE), an intermediate zoom position (MIDDLE), and a telephoto end (TELE), respectively, in an in-focus state at infinity. The spherical aberration diagram illustrates spherical aberration amounts for the d-line (wavelength 587.6 nm), g-line (wavelength 435.8 nm), C-line (wavelength 656.3 nm), and F-line (wavelength 486.1 nm) with a solid line, an alternate long and two short dashes line, and an alternate long and short dash line, respectively. The astigmatism diagram illustrates astigmatism amounts on a meridional image plane M and a sagittal image plane S with a broken line and a solid line, respectively. The distortion diagram illustrates a distortion amount for the d-line. The chromatic aberration diagram illustrates lateral chromatic aberration amounts for the d-line, g-line, C-line, and F-line with a solid line, an alternate long and two short dashes line, an alternate long and short dash line, and a broken line, respectively. Fno represents an F-number, and ω represents a half angle of view (°).

The full scale of the horizontal axis of the spherical aberration diagram is ±0.400 mm, and the full scale of the horizontal axis of the astigmatism diagram is also ±0.400 mm. The full scale of the horizontal axis of the distortion aberration diagram is ±5.000%. The full scale of the horizontal axis of the chromatic aberration diagram is ±0.100 mm. The above description of the aberration diagrams apply to the other numerical examples described later.

### Example 2

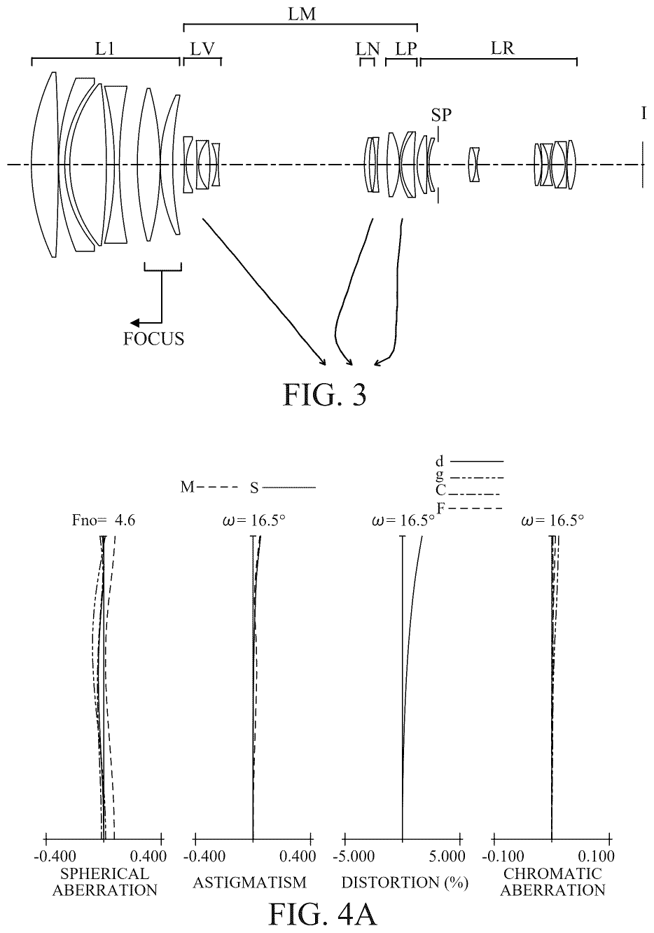

FIG. 3 illustrates the configuration of a zoom lens according to Example 2 (numerical example 2) at a wide-angle end in an in-focus state at infinity. In this example, the first lens unit L1 has first to twelfth surfaces, and includes two negative lenses and four positive lenses. The intermediate group LM has thirteenth to twenty-eighth surfaces. The first intermediate negative lens unit LV, which has twelfth to nineteenth surfaces, includes a single negative lens whose object-side surface is aspheric, two negative lenses, and a single positive lens.

The second intermediate negative lens unit LN, which has twentieth to twenty-third surfaces, includes a single negative lens and a single positive lens. The intermediate positive lens unit LP, which has twenty-forth to twenty-eighth surfaces, includes a single positive lens whose object-side surface is aspheric, a single negative lens, and a single positive lens. The rear lens unit LR has twenty-ninth to forty-sixth surfaces, and includes five negative lenses and six positive lenses. The aperture stop SP is a thirty-third surface.

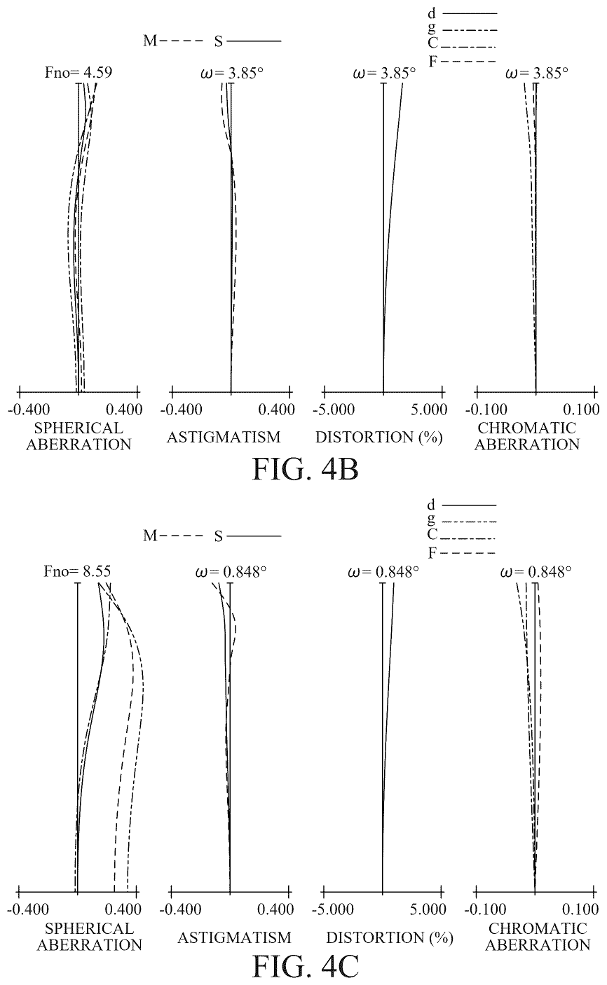

FIGS. 4A, 4B, and 4C illustrate longitudinal aberrations of the zoom lens according to numerical example 2 at a wide-angle end, an intermediate zoom position, and a telephoto end, respectively, in the in-focus state at infinity.

### Example 3

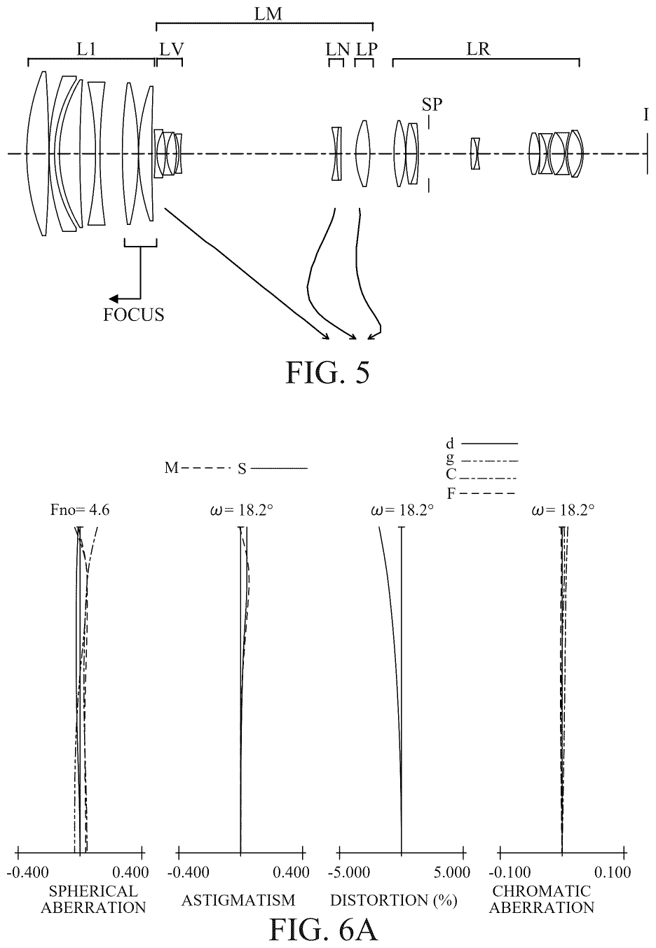

FIG. 5 illustrates the configuration of a zoom lens according to Example 3 (numerical example 3) at a wide-angle end in an in-focus state at infinity. In this example, the first lens unit L1 has first to twelfth surfaces, and includes two negative lenses and four positive lenses. The intermediate group LM has thirteenth to twenty-forth surfaces. The first intermediate negative lens unit LV, which has thirteenth to nineteenth surfaces, includes one negative lens whose object-side surface is aspherical, two negative lenses, and a single positive lens.

The second intermediate negative lens unit LN has twentieth to twenty-second surfaces and includes a single negative lens and a single positive lens. The intermediate positive lens unit LP has twenty-third and twenty-forth surfaces, and includes a single positive lens whose object-side and image-side surfaces are aspheric. The rear lens unit LR has twenty-fifth to forty-fourth surfaces and includes five negative lenses and seven positive lenses. The aperture stop SP is a thirtieth surface.

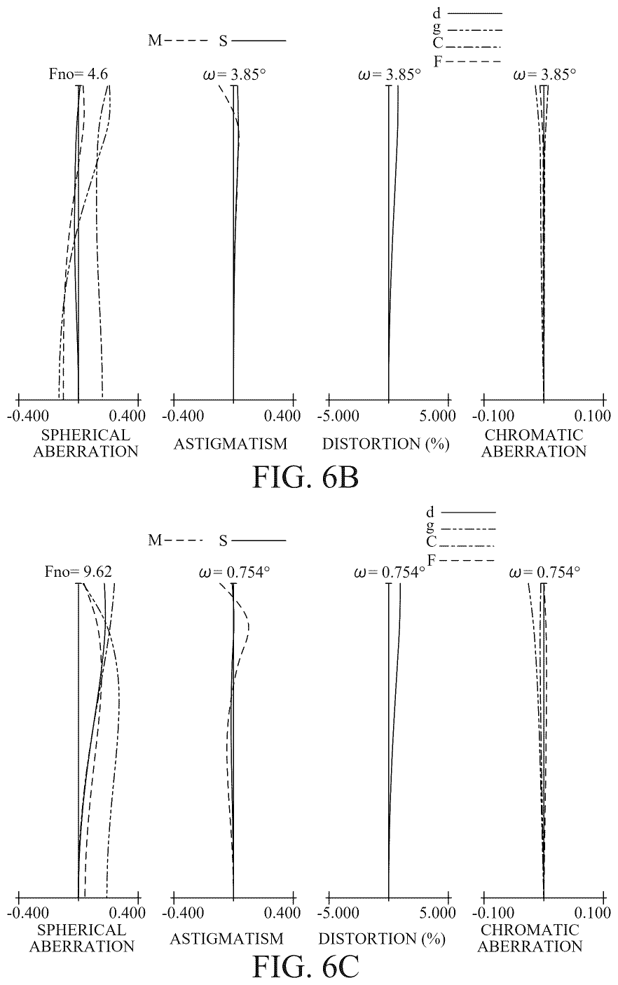

FIGS. 6A, 6B, and 6C illustrate the longitudinal aberrations of the zoom lens according to numerical example 3 at a wide-angle end, an intermediate zoom position, and a telephoto end, respectively, in the in-focus state at infinity.

### Example 4

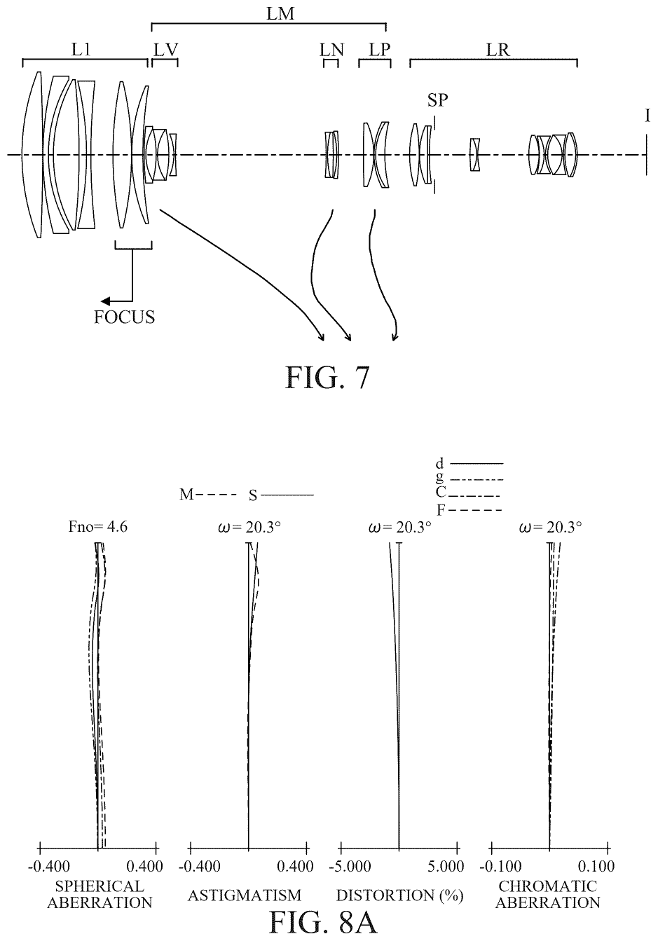

FIG. 7 illustrates the configuration of a zoom lens according to Example 4 (numerical example 4) at a wide-angle end and in an in-focus state at infinity. In this example, the first lens unit L1 has first to twelfth surfaces and includes two negative lenses and four positive lenses. The intermediate group LM has thirteenth to twenty-ninth surfaces. The first intermediate negative lens unit LV has thirteenth to nineteenth surfaces and includes a single negative lens whose object-side surface is aspheric, two negative lenses, and a single positive lens.

The second intermediate negative lens unit LN has twentieth to twenty-fourth surfaces and includes two negative lenses and a single positive lens. The intermediate positive lens unit LP has twenty-fifth to twenty-ninth surfaces, and includes a single positive lens whose object-side surface is aspheric, a single negative lens, and a single positive lens. The rear lens unit LR has thirtieth to forty-ninth surfaces and includes five negative lenses and seven positive lenses. The aperture stop SP is a thirty-fifth surface.

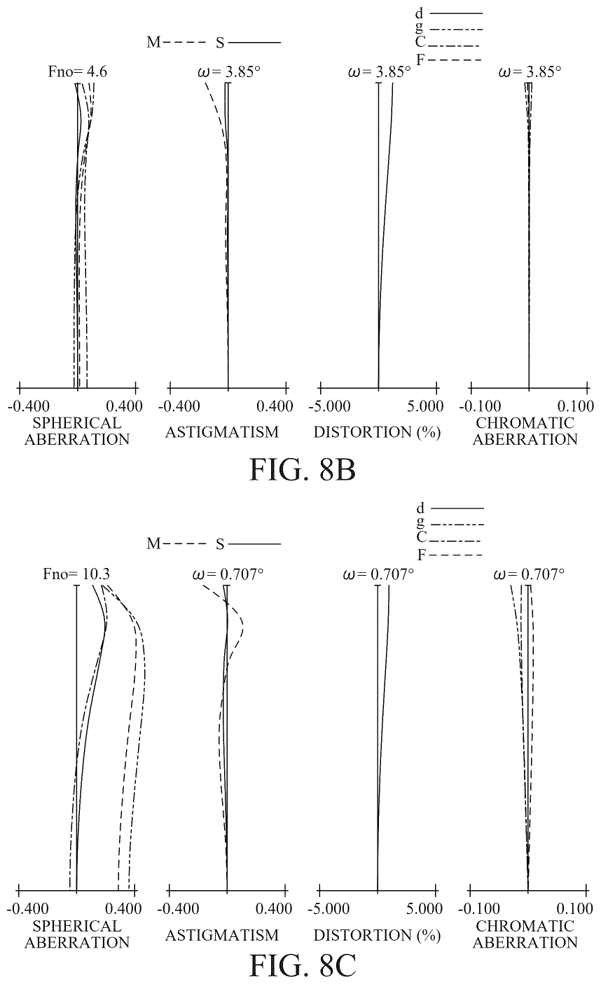

FIGS. 8A, 8B, and 8C illustrate the longitudinal aberrations of the zoom lens according to numerical example 4 at a wide-angle end, at an intermediate zoom position, and at a telephoto end, respectively, in the in-focus state at infinity.

### Example 5

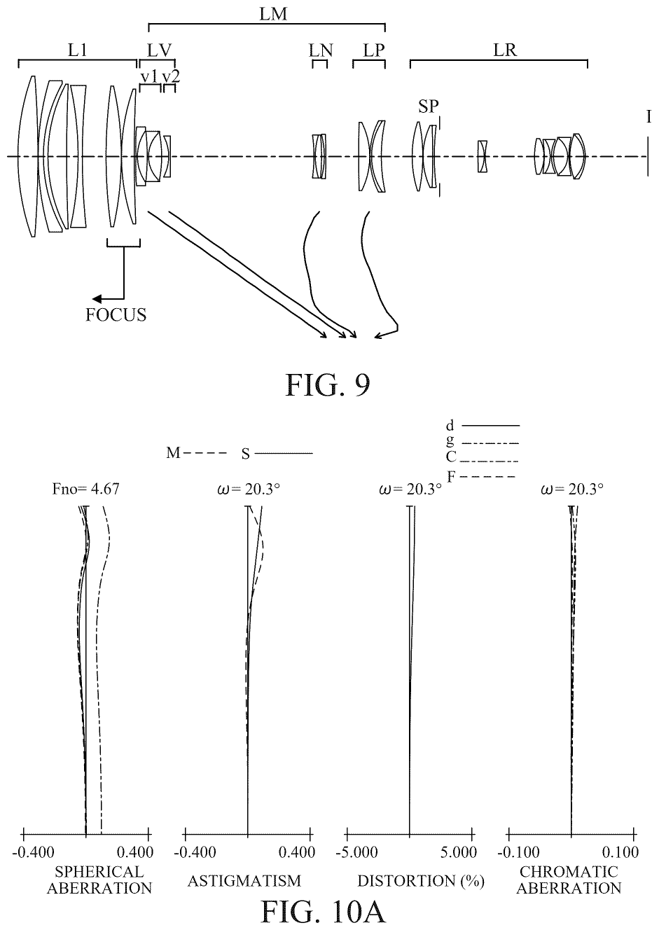

FIG. 9 illustrates the longitudinal aberrations of a zoom lens according to Example 5 (numerical example 5) at a wide-angle end in an in-focus state at infinity. In this example, the first lens unit L1 has first to twelfth surfaces, and includes two negative lenses and four positive lenses. The intermediate group LM has thirteenth to twenty-ninth surfaces.

The first intermediate negative lens unit LV includes the first partial lens unit LV1 and the second partial lens unit LV2 in order from the object side. The first partial lens unit LV1 and the second partial lens unit LV2 move monotonically toward the image side while changing a distance between them minutely (smaller than a change in the distance between other lens units) during zooming from the wide-angle end to the telephoto end. The first partial lens unit LV1 has thirteenth to seventeenth surfaces and includes a single negative lens whose object-side surface is aspheric, a single negative lens, and a single positive lens. The second partial lens unit LV2 has eighteenth to nineteenth surfaces and includes a single negative lens whose image-side surface is aspheric. The first intermediate negative lens unit LV may include three or more partial lens units.

The first partial lens unit LV1 and the second partial lens unit LV2 may be treated as independent, single lens units. For example, they may be treated as a negative lens unit corresponding to the first partial lens unit LV1 and a negative lens unit corresponding to the second partial lens unit LV2.

The second intermediate negative lens unit LN has twentieth to twenty-fourth surfaces and includes two negative lenses and a single positive lens. The intermediate positive lens unit LP has twenty-fifth to twenty-ninth surfaces and includes a single positive lens whose object-side surface is aspheric, a single negative lens, and a single positive lens. The rear lens unit LR has thirtieth to forty-ninth surfaces and includes five negative lenses and seven positive lenses. The aperture stop SP is a thirty-fifth surface.

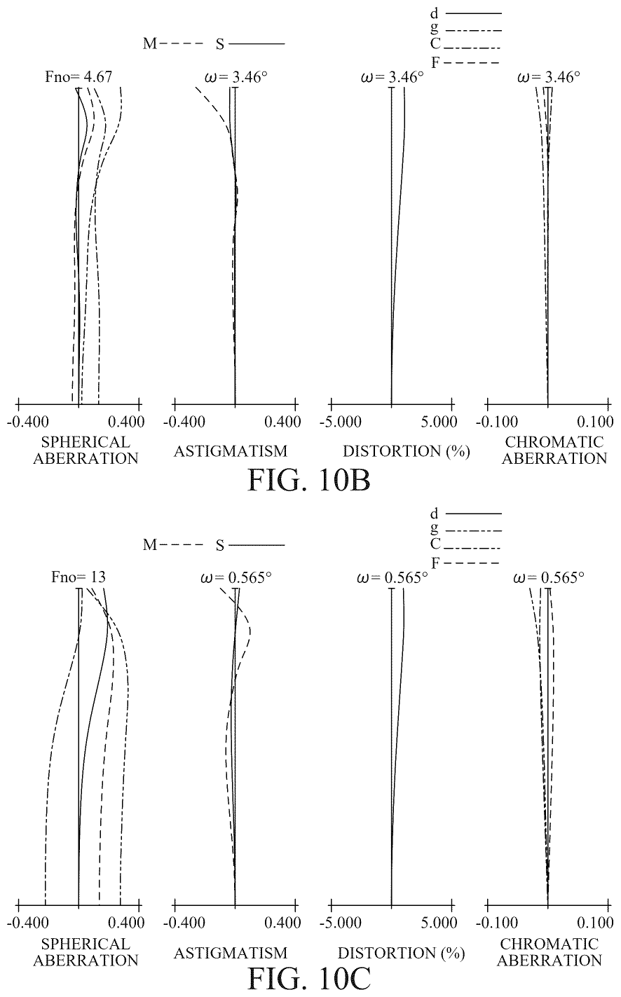

FIGS. 10A, 10B, and 10C illustrate the zoom lens according to numerical example 5 at a wide-angle end, an intermediate zoom position, and a telephoto end, respectively, in the in-focus state at infinity.

### Example 6

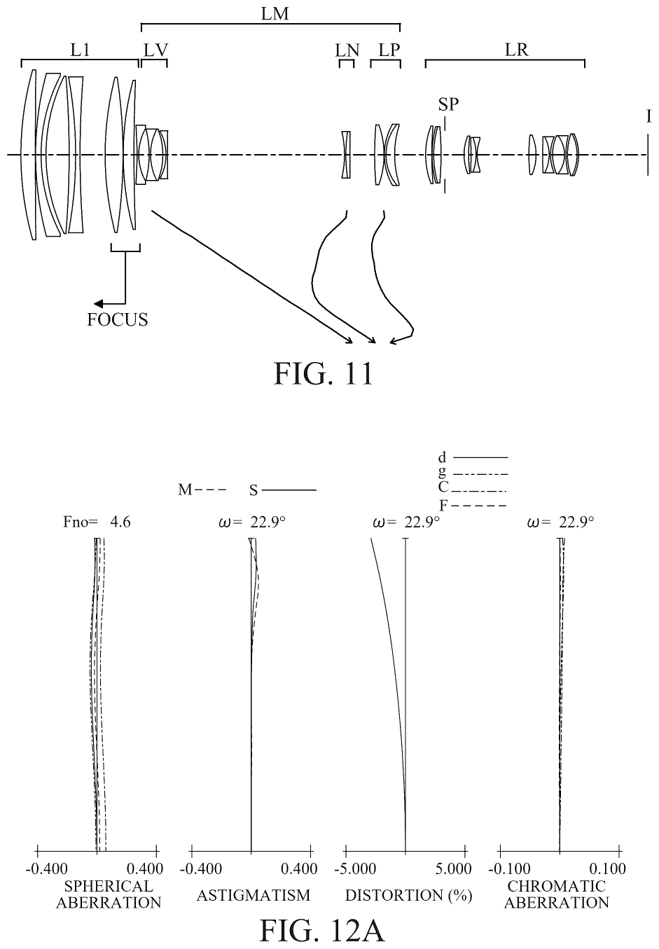

FIG. 11 illustrates the configuration of a zoom lens according to Example 6 (numerical example 6) at a wide-angle end in an in-focus state at infinity. In this example, the first lens unit L1 has first to twelfth surfaces, and includes two negative lenses and four positive lenses. The intermediate group LM has thirteenth to twenty-seventh surfaces. The first intermediate negative lens unit LV has thirteenth to nineteenth surfaces and includes a single negative lens whose object-side surface is aspherical, two negative lenses, and a single positive lens. The second intermediate negative lens unit LN has twentieth to twenty-second surfaces and includes a single negative lens and a single positive lens. The positive lens unit LP has twenty-third to twenty-seventh surfaces and includes a single positive lens whose object-side surface is aspheric, a single negative lens, and a single positive lens. The rear lens unit LR has twenty-eighth to forty-ninth surfaces and includes five negative lenses and eight positive lenses. The aperture stop SP is a thirty-third surface.

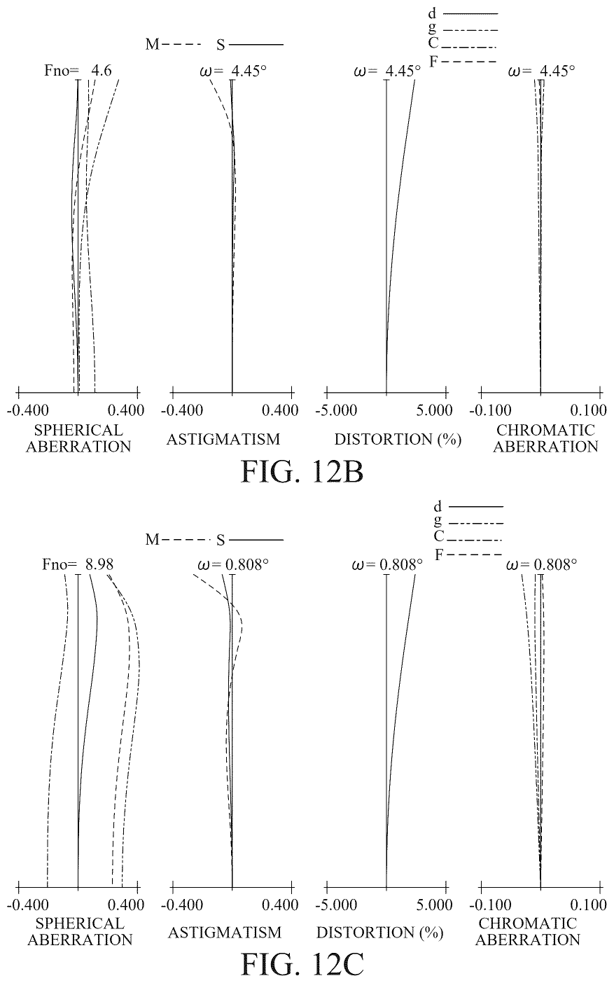

FIGS. 12A, 12B, and 12C illustrate the zoom lens according to numerical example 6 at a wide-angle end, an intermediate zoom position, and a telephoto end, respectively, in the in-focus state at infinity.

In the zoom lenses according to Examples 1 to 6, the rear lens unit LR does not move for zooming, but a partial lens unit that is a part of the rear lens unit may move, and the above effects can be obtained in this case as well. For example, in Example 1, a partial lens unit from thirty-seventh to forty-seventy surfaces in the rear lens unit LR may move. Since an approximately afocal light beam is incident on the thirty-seventh surface from the object side, even if this partial lens unit moves, the optical characteristic other than the back focus remain approximately unchanged. In addition, the movement of the partial lens unit can correct focus changes that accompany changes in the state of the zoom lens, such as zooming, focusing, operation of the aperture stop, temperature, air pressure, orientation, and insertion/removal of the magnification-varying optical system (extender).

NUMERICAL EXAMPLE 1
UNIT: mm
SURFACE DATA

| Surface No. | r | d | nd | νd | θgF |
|---|---|---|---|---|---|
| 1 | 161.551 | 16.13 | 1.49700 | 81.5 | 0.5375 |
| 2 | −948.095 | 0.20 | | | |
| 3 | 171.346 | 4.00 | 1.77250 | 49.6 | 0.5520 |
| 4 | 100.435 | 3.60 | | | |
| 5 | 104.049 | 16.19 | 1.43387 | 95.1 | 0.5373 |
| 6 | 1685.391 | 8.56 | | | |
| 7 | −251.961 | 3.20 | 1.72916 | 54.7 | 0.5444 |
| 8 | 388.842 | 15.63 | | | |
| 9 | 321.287 | 12.18 | 1.43387 | 95.1 | 0.5373 |
| 10 | −232.884 | 0.15 | | | |
| 11 | 145.177 | 9.40 | 1.43387 | 95.1 | 0.5373 |
| 12 | 968.682 | (Variable) | | | |
| 13* | −295.187 | 1.20 | 1.59522 | 67.7 | 0.5442 |
| 14 | 33.348 | 6.82 | | | |
| 15 | −65.974 | 1.00 | 1.59522 | 67.7 | 0.5442 |
| 16 | 27.520 | 8.50 | 1.72047 | 34.7 | 0.5834 |
| 17 | −47.897 | 2.47 | | | |
| 18 | −30.076 | 1.20 | 1.77250 | 49.6 | 0.5520 |
| 19 | 984.542 | (Variable) | | | |
| 20 | −69.448 | 1.00 | 1.77250 | 49.6 | 0.5520 |
| 21 | 129.752 | 3.26 | 1.92119 | 24.0 | 0.6203 |
| 22 | −2436.113 | (Variable) | | | |
| 23* | 294.629 | 7.12 | 1.43875 | 94.7 | 0.5340 |
| 24 | −63.833 | 0.20 | | | |
| 25 | 50.902 | 1.20 | 2.05090 | 26.9 | 0.6054 |
| 26 | 40.772 | 7.63 | 1.59522 | 67.7 | 0.5442 |
| 27 | 138.945 | (Variable) | | | |
| 28 | 105.524 | 5.94 | 1.51860 | 69.9 | 0.5318 |
| 29 | −126.376 | 0.20 | | | |
| 30 | 59.773 | 5.68 | 1.43875 | 94.7 | 0.5340 |
| 31 | −1164.171 | 1.20 | 2.00100 | 29.1 | 0.5997 |
| 32 | 147.018 | 4.04 | | | |
| 33 (SP) | ∞ | 31.31 | | | |
| 34 | −515.221 | 4.22 | 1.80810 | 22.8 | 0.6307 |
| 35 | −22.458 | 0.80 | 1.95375 | 32.3 | 0.5905 |
| 36 | 99.786 | 37.60 | | | |
| 37 | 47.943 | 6.76 | 1.51860 | 69.9 | 0.5318 |
| 38 | −35.664 | 0.17 | | | |
| 39 | −108.641 | 4.05 | 1.60342 | 38.0 | 0.5835 |
| 40 | −29.497 | 1.00 | 1.88300 | 40.8 | 0.5667 |
| 41 | 27.303 | 1.80 | | | |
| 42 | 29.813 | 11.40 | 1.76182 | 26.5 | 0.6136 |
| 43 | −19.084 | 1.00 | 2.00100 | 29.1 | 0.5997 |
| 44 | 83.726 | 0.64 | | | |
| 45 | 52.520 | 9.09 | 1.64769 | 33.8 | 0.5938 |
| 46 | −26.930 | 1.10 | 1.98612 | 16.5 | 0.6657 |
| 47 | −38.388 | 49.90 | | | |
| Image Plane | ∞ | | | | |

ASPHERIC DATA

13th Surface
K = −1.18082e+00 A 4 = 4.07830e−06 A 6 = 7.17765e−10 A 8 = −5.40864e−12
A10 = 5.06878e−14 A12 = −1.25398e−16 A14 = 1.04671e−19 A16 = 6.53328e−23
23rd Surface
K = 0.00000e+00 A 4 = −1.12738e−06 A 6 = 2.39065e−11 A 8 = −1.48685e−13

VARIOUS DATA
ZOOM RATIO 30.00

| | WIDE | MIDDLE | TELE |
|---|---|---|---|
| Focal Length | 40.00 | 220.00 | 1200.00 |
| Fno | 4.60 | 4.60 | 10.00 |
| Half Angle of View (°) | 20.30 | 3.85 | 0.71 |
| Image Height | 14.80 | 14.80 | 14.80 |
| Overall Lens Length | 455.16 | 455.16 | 455.16 |
| BF | 49.90 | 49.90 | 49.90 |
| d12 | 1.68 | 89.54 | 121.68 |
| d19 | 116.23 | 8.11 | 7.06 |
| d22 | 13.29 | 37.96 | 1.96 |
| d27 | 15.22 | 10.81 | 15.72 |

LENS UNIT DATA

| Lens Unit | Starting Surface | Focal Length |
|---|---|---|
| 1 | 1 | 195.06 |
| 2 | 13 | −25.06 |
| 3 | 20 | −104.35 |
| 4 | 23 | 71.04 |
| 5 | 28 | 253.10 |

NUMERICAL EXAMPLE 2
UNIT: mm
SURFACE DATA

| Surface No. | r | d | nd | νd | θgF |
|---|---|---|---|---|---|
| 1 | 138.810 | 17.65 | 1.48749 | 70.2 | 0.5300 |
| 2 | −1097.218 | 0.20 | | | |
| 3 | 144.845 | 4.00 | 1.77250 | 49.6 | 0.5520 |
| 4 | 80.525 | 3.30 | | | |
| 5 | 81.788 | 23.99 | 1.43387 | 95.1 | 0.5373 |
| 6 | −415.122 | 5.30 | | | |
| 7 | −202.823 | 3.20 | 1.72916 | 54.7 | 0.5444 |
| 8 | 257.764 | 11.77 | | | |
| 9 | 193.666 | 14.93 | 1.43387 | 95.1 | 0.5373 |
| 10 | −187.833 | 0.15 | | | |
| 11 | 105.178 | 8.08 | 1.43875 | 94.9 | 0.5340 |
| 12 | 214.366 | (Variable) | | | |
| 13* | −175.753 | 1.20 | 1.69930 | 51.1 | 0.5552 |
| 14 | 34.554 | 7.09 | | | |
| 15 | −285.388 | 1.00 | 1.53775 | 74.7 | 0.5392 |
| 16 | 23.984 | 7.45 | 1.73800 | 32.3 | 0.5900 |
| 17 | −104.372 | 4.30 | | | |
| 18 | −33.528 | 1.20 | 1.72916 | 54.7 | 0.5444 |
| 19 | 113.996 | (Variable) | | | |
| 20 | 60.546 | 3.22 | 1.84666 | 23.8 | 0.6205 |
| 21 | 90.761 | 3.98 | | | |
| 22 | −90.201 | 1.20 | 1.72916 | 54.7 | 0.5444 |
| 23 | 143.298 | (Variable) | | | |
| 24* | 115.215 | 8.11 | 1.43875 | 94.7 | 0.5340 |
| 25 | −50.693 | 0.20 | | | |
| 26 | 43.991 | 1.20 | 2.00069 | 25.5 | 0.6136 |
| 27 | 33.683 | 8.22 | 1.59522 | 67.7 | 0.5442 |
| 28 | 214.033 | (Variable) | | | |
| 29 | 40.173 | 6.46 | 1.43875 | 94.7 | 0.5340 |
| 30 | −509.769 | 0.20 | | | |
| 31 | 59.218 | 1.20 | 2.00100 | 29.1 | 0.5997 |
| 32 | 40.334 | 5.94 | | | |
| 33 (SP) | ∞ | 19.98 | | | |
| 34 | 56.580 | 4.67 | 1.80810 | 22.8 | 0.6307 |
| 35 | −28.993 | 0.80 | 1.95375 | 32.3 | 0.5905 |
| 36 | 35.473 | 37.60 | | | |
| 37 | 129.653 | 4.75 | 1.57501 | 41.5 | 0.5767 |
| 38 | −37.617 | 0.25 | | | |
| 39 | −84.905 | 4.14 | 1.56732 | 42.8 | 0.5731 |
| 40 | −26.352 | 1.00 | 1.88300 | 40.8 | 0.5667 |
| 41 | 53.228 | 1.08 | | | |
| 42 | 43.345 | 8.99 | 1.63980 | 34.5 | 0.5922 |
| 43 | −23.250 | 1.00 | 2.00100 | 29.1 | 0.5997 |
| 44 | −353.793 | 0.19 | | | |
| 45 | 89.816 | 5.61 | 1.59551 | 39.2 | 0.5803 |
| 46 | −47.048 | 43.98 | | | |
| Image Plane | ∞ | | | | |

ASPHERIC DATA

13th Surface
K = −1.71296e+00 A 4 = 3.65648e−06 A 6 = −7.05147e−10 A 8 = −3.84223e−13
A10 = 3.30964e−14 A12 = −1.90987e−16 A14 = 5.13656e−19 A16 = −5.30788e−22
24th Surface
K = 0.00000e+00 A 4 = −2.67796e−06 A 6 = 5.34861e−10 A 8 = −1.47716e−13

VARIOUS DATA
ZOOM RATIO 20.00

| | WIDE | MIDDLE | TELE |
|---|---|---|---|
| Focal Length | 50.00 | 220.00 | 1000.00 |
| Fno | 4.60 | 4.60 | 8.55 |
| Half Angle of View (°) | 16.49 | 3.85 | 0.85 |
| Image Height | 14.80 | 14.80 | 14.80 |
| Overall Lens Length | 400.53 | 400.53 | 400.53 |
| BF | 43.98 | 43.98 | 43.98 |
| d12 | 7.67 | 65.79 | 87.67 |
| d19 | 95.70 | 13.96 | 2.07 |
| d23 | 6.40 | 26.00 | 1.97 |
| d28 | 1.98 | 6.00 | 20.03 |

LENS UNIT DATA

| Lens Unit | Starting Surface | Focal Length |
|---|---|---|
| 1 | 1 | 166.07 |
| 2 | 13 | −22.61 |
| 3 | 20 | −129.50 |
| 4 | 24 | 48.42 |
| 5 | 29 | 6430.16 |

NUMERICAL EXAMPLE 3
UNIT: mm
SURFACE DATA

| Surface No. | r | d | nd | νd | θgF |
|---|---|---|---|---|---|
| 1 | 160.363 | 16.21 | 1.49700 | 81.5 | 0.5375 |
| 2 | −789.513 | 0.20 | | | |
| 3 | 165.662 | 4.00 | 1.77250 | 49.6 | 0.5520 |
| 4 | 99.928 | 3.57 | | | |
| 5 | 103.373 | 15.00 | 1.43387 | 95.1 | 0.5373 |
| 6 | 762.000 | 11.55 | | | |
| 7 | −242.547 | 3.20 | 1.72916 | 54.7 | 0.5444 |
| 8 | 366.855 | 16.41 | | | |
| 9 | 361.413 | 11.80 | 1.43387 | 95.1 | 0.5373 |
| 10 | −220.022 | 0.15 | | | |
| 11 | 146.506 | 9.67 | 1.43875 | 94.9 | 0.5340 |
| 12 | 1341.013 | (Variable) | | | |
| 13* | −145.353 | 1.20 | 1.53775 | 74.7 | 0.5392 |
| 14 | 31.534 | 6.22 | | | |
| 15 | −70.009 | 1.00 | 1.52841 | 76.5 | 0.5396 |
| 16 | 30.782 | 7.03 | 1.76634 | 35.8 | 0.5792 |
| 17 | −62.868 | 1.87 | | | |
| 18 | −39.946 | 1.20 | 1.77250 | 49.6 | 0.5520 |
| 19 | 117.269 | (Variable) | | | |
| 20 | −68.392 | 1.00 | 1.72916 | 54.7 | 0.5444 |
| 21 | 142.635 | 3.11 | 1.92119 | 24.0 | 0.6203 |
| 22 | 2987.046 | (Variable) | | | |
| 23* | 51.791 | 10.29 | 1.43875 | 94.7 | 0.5340 |
| 24* | −92.944 | (Variable) | | | |
| 25 | 101.269 | 8.58 | 1.48749 | 70.2 | 0.5300 |
| 26 | −69.900 | 0.20 | | | |
| 27 | 115.977 | 7.92 | 1.43875 | 94.7 | 0.5340 |
| 28 | −57.389 | 1.20 | 2.00100 | 29.1 | 0.5997 |
| 29 | −221.465 | 7.59 | | | |
| 30 (SP) | ∞ | 30.96 | | | |
| 31 | 129.704 | 4.34 | 1.80810 | 22.8 | 0.6307 |
| 32 | −28.640 | 0.80 | 1.95375 | 32.3 | 0.5905 |
| 33 | 48.513 | 37.60 | | | |
| 34 | 52.241 | 7.75 | 1.51633 | 64.1 | 0.5353 |
| 35 | −37.812 | 0.16 | | | |
| 36 | −111.053 | 4.75 | 1.60342 | 38.0 | 0.5835 |
| 37 | −27.496 | 1.00 | 1.88300 | 40.8 | 0.5667 |
| 38 | 32.716 | 1.56 | | | |
| 39 | 33.408 | 10.71 | 1.85478 | 24.8 | 0.6122 |
| 40 | −21.733 | 1.00 | 2.00100 | 29.1 | 0.5997 |
| 41 | 48.205 | 1.21 | | | |
| 42 | 43.954 | 10.39 | 1.60342 | 38.0 | 0.5835 |
| 43 | −24.443 | 1.10 | 1.95906 | 17.5 | 0.6598 |
| 44 | −35.431 | 47.09 | | | |
| Image Plane | ∞ | | | | |

ASPHERIC DATA

13th Surface
K = 1.98235e+00 A 4 = 3.46474e−06 A 6 = −1.08846e−09 A 8 = 1.60965e−12
A10 = −2.29039e−15 A12 = 2.12071e−17 A14 = −5.50356e−20 A16 = 4.35851e−23
23rd Surface
K = 0.00000e+00 A 4 = −1.79332e−06 A 6 = 5.48389e−10 A 8 = −2.57959e−13
24th Surface
K = 0.00000e+00 A 4 = 1.09898e−06 A 6 = 4.54644e−10 A 8 = 6.59687e−14

VARIOUS DATA
ZOOM RATIO 25.00

| | WIDE | MIDDLE | TELE |
|---|---|---|---|
| Focal Length | 45.00 | 220.00 | 1125.00 |
| Fno | 4.60 | 4.60 | 9.62 |
| Half Angle of View (°) | 18.21 | 3.85 | 0.75 |
| Image Height | 14.80 | 14.80 | 14.80 |
| Overall Lens Length | 455.25 | 455.25 | 455.25 |
| BF | 47.09 | 47.09 | 47.09 |
| d12 | 2.55 | 87.18 | 122.51 |
| d19 | 113.58 | 10.47 | 8.82 |
| d22 | 10.88 | 33.98 | 1.95 |
| d24 | 17.67 | 13.04 | 11.38 |

LENS UNIT DATA

| Lens Unit | Starting Surface | Focal Length |
|---|---|---|
| 1 | 1 | 200.16 |
| 2 | 13 | −26.47 |
| 3 | 20 | −103.93 |
| 4 | 23 | 77.48 |
| 5 | 25 | 201.58 |

NUMERICAL EXAMPLE 4
UNIT: mm
SURFACE DATA

| Surface No. | r | d | nd | νd | θgF |
|---|---|---|---|---|---|
| 1 | 165.030 | 15.30 | 1.48749 | 70.2 | 0.5300 |
| 2 | −1313.308 | 0.20 | | | |
| 3 | 218.690 | 4.00 | 1.77250 | 49.6 | 0.5520 |
| 4 | 107.799 | 3.66 | | | |
| 5 | 112.723 | 18.98 | 1.43387 | 95.1 | 0.5373 |
| 6 | −503.677 | 5.43 | | | |
| 7 | −228.473 | 3.20 | 1.72916 | 54.7 | 0.5444 |
| 8 | 486.081 | 16.29 | | | |
| 9 | 269.883 | 13.71 | 1.43387 | 95.1 | 0.5373 |
| 10 | −225.795 | 0.15 | | | |
| 11 | 128.440 | 8.20 | 1.43387 | 95.1 | 0.5373 |
| 12 | 303.829 | (Variable) | | | |
| 13* | 300.010 | 1.20 | 1.69680 | 55.5 | 0.5434 |
| 14 | 37.805 | 7.60 | | | |
| 15 | −75.928 | 1.00 | 1.53775 | 74.7 | 0.5392 |
| 16 | 32.390 | 8.36 | 1.78880 | 28.4 | 0.6009 |
| 17 | −75.065 | 3.70 | | | |
| 18 | −38.040 | 1.20 | 1.89190 | 37.1 | 0.5780 |
| 19 | 205.380 | (Variable) | | | |
| 20 | −208.092 | 1.00 | 1.81600 | 46.6 | 0.5568 |
| 21 | 65.632 | 4.20 | 1.78880 | 28.4 | 0.6009 |
| 22 | −392.329 | 2.59 | | | |
| 23 | −65.175 | 1.20 | 1.76385 | 48.5 | 0.5589 |
| 24 | −242.068 | (Variable) | | | |
| 25* | 309.873 | 7.72 | 1.43875 | 94.7 | 0.5340 |
| 26 | −58.171 | 0.20 | | | |
| 27 | 51.920 | 1.20 | 2.00069 | 25.5 | 0.6136 |
| 28 | 42.906 | 6.74 | 1.59522 | 67.7 | 0.5442 |
| 29 | 100.977 | (Variable) | | | |
| 30 | 79.282 | 7.09 | 1.43875 | 94.7 | 0.5340 |
| 31 | −120.764 | 0.20 | | | |
| 32 | 53.635 | 6.03 | 1.43875 | 94.7 | 0.5340 |
| 33 | −3034.900 | 1.20 | 2.00100 | 29.1 | 0.5997 |
| 34 | 149.884 | 4.02 | | | |
| 35 (SP) | ∞ | 26.05 | | | |
| 36 | 123.165 | 4.87 | 1.80810 | 22.8 | 0.6307 |
| 37 | −26.296 | 0.80 | 1.95375 | 32.3 | 0.5905 |
| 38 | 45.378 | 37.60 | | | |
| 39 | 50.473 | 7.57 | 1.48749 | 70.2 | 0.5300 |
| 40 | −33.478 | 0.19 | | | |
| 41 | −60.696 | 3.55 | 1.62588 | 35.7 | 0.5893 |
| 42 | −29.626 | 1.00 | 1.71700 | 47.9 | 0.5605 |
| 43 | 26.472 | 1.61 | | | |
| 44 | 27.624 | 10.60 | 1.69895 | 30.1 | 0.6030 |
| 45 | −19.972 | 1.00 | 2.00100 | 29.1 | 0.5997 |
| 46 | 58.122 | 1.06 | | | |
| 47 | 47.761 | 8.00 | 1.64769 | 33.8 | 0.5938 |
| 48 | −32.145 | 1.10 | 1.95906 | 17.5 | 0.6598 |
| 49 | −40.304 | 51.10 | | | |
| Image Plane | ∞ | | | | |

ASPHERIC DATA

13th Surface
K = −1.99830e+00 A 4 = 1.72502e−06 A 6 = 9.97353e−10 A 8 = −3.37565e−12
A10 = 2.99247e−14 A12 = −9.88585e−17 A14 = 1.67968e−19 A16 = −1.09038e−22
25th Surface
K = 0.00000e+00 A 4 = −1.22645e−06 A 6 = 7.17200e−11 A 8 = −1.39369e−13

VARIOUS DATA
ZOOM RATIO 30.00

| | WIDE | MIDDLE | TELE |
|---|---|---|---|
| Focal Length | 40.00 | 220.00 | 1200.00 |
| Fno | 4.60 | 4.60 | 10.26 |
| Half Angle of View (°) | 20.30 | 3.85 | 0.71 |
| Image Height | 14.80 | 14.80 | 14.80 |
| Overall Lens Length | 460.35 | 460.35 | 460.35 |
| BF | 51.10 | 51.10 | 51.10 |
| d12 | 1.00 | 92.09 | 126.00 |
| d19 | 111.05 | 6.75 | 3.10 |
| d24 | 18.38 | 37.72 | 1.94 |
| d29 | 18.26 | 12.13 | 17.64 |

LENS UNIT DATA

| Lens Unit | Starting Surface | Focal Length |
|---|---|---|
| 1 | 1 | 199.61 |
| 2 | 13 | −27.46 |
| 3 | 20 | −90.98 |
| 4 | 25 | 73.97 |
| 5 | 30 | 242.73 |

NUMERICAL EXAMPLE 5
UNIT: mm
SURFACE DATA

| Surface No. | r | d | nd | νd | θgF |
|---|---|---|---|---|---|
| 1 | 180.137 | 15.28 | 1.49700 | 81.5 | 0.5375 |
| 2 | −789.237 | 0.20 | | | |
| 3 | 198.814 | 4.00 | 1.77250 | 49.6 | 0.5520 |
| 4 | 112.942 | 3.46 | | | |
| 5 | 116.871 | 14.26 | 1.43387 | 95.1 | 0.5373 |
| 6 | 1241.126 | 8.75 | | | |
| 7 | −251.002 | 3.20 | 1.72916 | 54.7 | 0.5444 |
| 8 | 506.225 | 18.11 | | | |
| 9 | 385.502 | 11.64 | 1.43387 | 95.1 | 0.5373 |
| 10 | −241.896 | 0.15 | | | |
| 11 | 150.904 | 9.72 | 1.43875 | 94.9 | 0.5340 |
| 12 | 1094.599 | (Variable) | | | |
| 13* | −484.077 | 1.20 | 1.43875 | 94.7 | 0.5340 |
| 14 | 34.038 | 7.44 | | | |
| 15 | −170.791 | 1.00 | 1.72916 | 54.7 | 0.5444 |
| 16 | 24.472 | 10.03 | 1.76634 | 35.8 | 0.5792 |
| 17 | −94.125 | (Variable) | | | |
| 18 | −32.819 | 1.20 | 1.72916 | 54.7 | 0.5444 |
| 19* | 2578.580 | (Variable) | | | |
| 20 | −113.177 | 1.00 | 1.77250 | 49.6 | 0.5520 |
| 21 | 55.549 | 4.74 | 1.78880 | 28.4 | 0.6009 |
| 22 | −176.378 | 2.12 | | | |
| 23 | −64.063 | 1.20 | 1.88300 | 40.8 | 0.5667 |
| 24 | −379.478 | (Variable) | | | |
| 25* | 494.977 | 8.41 | 1.43875 | 94.7 | 0.5340 |
| 26 | −57.733 | 0.20 | | | |
| 27 | 59.015 | 1.20 | 2.00069 | 25.5 | 0.6136 |
| 28 | 48.014 | 7.41 | 1.59522 | 67.7 | 0.5442 |
| 29 | 126.247 | (Variable) | | | |
| 30 | 84.799 | 8.13 | 1.49700 | 81.5 | 0.5375 |
| 31 | −127.181 | 0.20 | | | |
| 32 | 54.553 | 7.37 | 1.43875 | 94.7 | 0.5340 |
| 33 | −504.241 | 1.20 | 2.00100 | 29.1 | 0.5997 |
| 34 | 189.224 | 3.96 | | | |
| 35 (SP) | ∞ | 29.33 | | | |
| 36 | 242.230 | 4.79 | 1.80810 | 22.8 | 0.6307 |
| 37 | −24.515 | 0.80 | 1.95375 | 32.3 | 0.5905 |
| 38 | 48.987 | 37.60 | | | |
| 39 | 58.665 | 7.22 | 1.48749 | 70.2 | 0.5300 |
| 40 | −28.824 | 0.14 | | | |
| 41 | −83.714 | 4.52 | 1.62588 | 35.7 | 0.5893 |
| 42 | −22.600 | 1.00 | 1.88300 | 40.8 | 0.5667 |
| 43 | 28.400 | 1.59 | | | |
| 44 | 29.985 | 10.75 | 1.78472 | 25.7 | 0.6161 |
| 45 | −16.678 | 1.00 | 2.00100 | 29.1 | 0.5997 |
| 46 | 62.135 | 0.73 | | | |
| 47 | 44.975 | 10.62 | 1.63980 | 34.5 | 0.5922 |
| 48 | −22.382 | 1.10 | 1.95906 | 17.5 | 0.6598 |
| 49 | −31.899 | 47.86 | | | |
| Image Plane | ∞ | | | | |

ASPHERIC DATA

13th Surface
K = 2.03811e+00 A 4 = 4.46960e−06 A 6 = −3.73984e−09 A 8 = 3.24444e−11
A10 = −1.53241e−13 A12 = 4.01107e−16 A14 = −5.27746e−19 A16 = 2.79747e−22
19th Surface
K = 0.00000e+00 A 4 = 1.70977e−07 A 6 = −9.87190e−09 A 8 = 2.03848e−10
A10 = −2.27112e−12 A12 = 1.35250e−14 A14 = −4.07636e−17 A16 = 4.89496e−20
25th Surface
K = 0.00000e+00 A 4 = −1.01951e−06 A 6 = 6.03432e−11 A 8 = −1.16440e−13

VARIOUS DATA
ZOOM RATIO 37.50

| | WIDE | MIDDLE | TELE |
|---|---|---|---|
| Focal Length | 40.00 | 245.00 | 1500.00 |
| Fno | 4.67 | 4.67 | 12.95 |
| Half Angle of View (°) | 20.30 | 3.46 | 0.57 |
| Image Height | 14.80 | 14.80 | 14.80 |
| Overall Lens Length | 480.70 | 480.70 | 480.70 |
| BF | 47.86 | 47.86 | 47.86 |
| d12 | 1.25 | 101.72 | 137.29 |
| d17 | 5.36 | 4.09 | 3.90 |
| d19 | 109.64 | 6.63 | 2.96 |
| d24 | 25.06 | 39.17 | 1.86 |
| d29 | 23.55 | 13.24 | 18.84 |

LENS UNIT DATA

| Lens Unit | Starting Surface | Focal Length |
|---|---|---|
| 1 | 1 | 210.69 |
| 2 | 13 | −143.37 |
| 3 | 18 | −44.44 |
| 4 | 20 | −73.06 |
| 5 | 25 | 78.18 |
| 6 | 30 | 241.93 |

NUMERICAL EXAMPLE 6
UNIT: mm
SURFACE DATA

| Surface No. | r | d | nd | νd | θgF |
|---|---|---|---|---|---|
| 1 | 223.553 | 10.47 | 1.49700 | 81.5 | 0.5375 |
| 2 | 4872.086 | 0.20 | | | |
| 3 | 222.915 | 4.00 | 1.77250 | 49.6 | 0.5520 |
| 4 | 122.849 | 3.56 | | | |
| 5 | 128.542 | 16.84 | 1.43387 | 95.1 | 0.5373 |
| 6 | −675.158 | 4.69 | | | |
| 7 | −305.451 | 3.20 | 1.72916 | 54.7 | 0.5444 |
| 8 | 707.100 | 18.23 | | | |
| 9 | 219.674 | 13.02 | 1.43387 | 95.1 | 0.5373 |
| 10 | −361.396 | 0.15 | | | |
| 11 | 203.109 | 7.80 | 1.43387 | 95.1 | 0.5373 |
| 12 | 1310.329 | (Variable) | | | |
| 13* | −166.991 | 1.20 | 1.59522 | 67.7 | 0.5442 |
| 14 | 39.134 | 7.57 | | | |
| 15 | −74.564 | 1.00 | 1.61800 | 63.3 | 0.5441 |
| 16 | 39.845 | 8.95 | 1.72047 | 34.7 | 0.5834 |
| 17 | −49.455 | 2.28 | | | |
| 18 | −35.140 | 1.20 | 1.69680 | 55.5 | 0.5434 |
| 19 | 10411.645 | (Variable) | | | |
| 20 | −72.656 | 1.00 | 1.74100 | 52.6 | 0.5467 |
| 21 | 116.868 | 2.91 | 1.92119 | 24.0 | 0.6203 |
| 22 | 1161.315 | (Variable) | | | |
| 23* | 207.814 | 6.86 | 1.43875 | 94.7 | 0.5340 |
| 24 | −62.876 | 0.20 | | | |
| 25 | 43.874 | 1.20 | 2.05090 | 26.9 | 0.6054 |
| 26 | 34.099 | 6.29 | 1.59522 | 67.7 | 0.5442 |
| 27 | 69.479 | (Variable) | | | |
| 28 | 57.769 | 4.44 | 1.51860 | 69.9 | 0.5318 |
| 29 | 235.920 | 0.20 | | | |
| 30 | 77.694 | 1.20 | 2.00100 | 29.1 | 0.5997 |
| 31 | 72.492 | 5.35 | 1.43875 | 94.7 | 0.5340 |
| 32 | −215.992 | 2.78 | | | |
| 33 (SP) | ∞ | 13.92 | | | |
| 34 | 35.798 | 3.37 | 1.54814 | 45.8 | 0.5686 |
| 35 | 112.952 | 1.65 | | | |
| 36 | −4564.752 | 3.70 | 1.80810 | 22.8 | 0.6307 |
| 37 | −35.558 | 0.80 | 1.95375 | 32.3 | 0.5905 |
| 38 | 31.225 | 37.60 | | | |
| 39 | 126.474 | 5.21 | 1.51860 | 69.9 | 0.5318 |
| 40 | −36.239 | 4.82 | | | |
| 41 | 783.670 | 4.68 | 1.63980 | 34.5 | 0.5922 |
| 42 | −27.602 | 1.00 | 1.88300 | 40.8 | 0.5667 |
| 43 | 33.127 | 1.54 | | | |
| 44 | 33.990 | 8.63 | 1.76182 | 26.5 | 0.6136 |
| 45 | −22.163 | 1.00 | 2.00100 | 29.1 | 0.5997 |
| 46 | 56.905 | 1.15 | | | |
| 47 | 47.481 | 6.99 | 1.54814 | 45.8 | 0.5686 |
| 48 | −33.602 | 1.10 | 1.98612 | 16.5 | 0.6657 |
| 49 | −37.135 | 50.41 | | | |
| Image Plane | ∞ | | | | |

ASPHERIC DATA

13th Surface
K = 1.85228e+00 A 4 = 2.97887e−06 A 6 = −3.95919e−10 A 8 = 3.16332e−12
A10 = −1.72732e−14 A12 = 5.61306e−17 A14 = −8.21795e−20 A16 = 4.86328e−23
23rd Surface
K = 0.00000e+00 A 4 = −9.86545e−07 A 6 = 4.93421e−11 A 8 = −8.03224e−15

VARIOUS DATA
ZOOM RATIO 30.00

| | WIDE | MIDDLE | TELE |
|---|---|---|---|
| Focal Length | 35.00 | 190.00 | 1050.00 |
| Fno | 4.60 | 4.60 | 8.98 |
| Half Angle of View (°) | 22.92 | 4.45 | 0.81 |
| Image Height | 14.80 | 14.80 | 14.80 |
| Overall Lens Length | 455.65 | 455.65 | 455.65 |
| BF | 50.41 | 50.41 | 50.41 |
| d12 | 2.26 | 106.45 | 147.54 |
| d19 | 128.50 | 5.85 | 3.79 |
| d22 | 17.98 | 42.50 | 1.93 |
| d27 | 22.55 | 16.48 | 18.03 |

LENS UNIT DATA

| Lens Unit | Starting Surface | Focal Length |
|---|---|---|
| 1 | 1 | 213.01 |
| 2 | 13 | −30.76 |
| 3 | 20 | −105.75 |
| 4 | 23 | 82.62 |
| 5 | 28 | 196.68 |

TABLE 1

| | Numerical example | | | | | |
|---|---|---|---|---|---|---|
| Inequality | 1 | 2 | 3 | 4 | 5 | 6 |
| (1) ft/fl | 6.15 | 6.02 | 5.62 | 6.01 | 7.12 | 4.93 |
| (2) fl/fv | −7.78 | −7.35 | −7.56 | −7.27 | −7.38 | −6.92 |
| (3)(fl + ok1}/f1 | 0.80 | 0.74 | 0.79 | 0.83 | 0.83 | 0.88 |
| (4) βvw | −0.204 | −0.266 | −0.214 | −0.216 | −0.211 | −0.208 |
| (5) βvt | −8.35 | −4.52 | −6.78 | −12.65 | −982.81 | −10.48 |
| (6) ft\|/mv\| | 10.00 | 12.50 | 9.38 | 9.60 | 11.03 | 7.23 |
| (7) f1/fp | 2.75 | 3.43 | 2.58 | 2.70 | 2.69 | 2.58 |
| (8) fl/fn | −1.87 | −1.28 | −1.93 | −2.19 | −2.88 | −2.01 |
| (9) θ g F1N − θ g FIP | 0.011 | 0.014 | 0.012 | 0.013 | 0.012 | 0.011 |
| (10) θ g Fv − θ g FvP | −0.037 | −0.044 | −0.036 | −0.047 | −0.038 | −0.040 |
| (11) νd1P | 91.70 | 88.83 | 91.65 | 88.88 | 91.65 | 91.70 |

TABLE 2

| | Numerical example | | | | | |
|---|---|---|---|---|---|---|
| Inequality | 1 | 2 | 3 | 4 | 5 | 6 |
| ft | 1200.00 | 1000.00 | 1125.00 | 1200.00 | 1500.00 | 1050.00 |
| fl | 195.06 | 166.07 | 200.16 | 199.61 | 210.69 | 213.01 |
| fv | −25.06 | −22.61 | −26.47 | −27.46 | −28.54 | −30.76 |
| ok1 | −38.94 | −43.22 | −41.56 | −34.87 | −35.29 | −26.43 |
| βvw | −0.20 | −0.27 | −0.21 | −0.22 | −0.21 | −0.21 |
| βvt | −8.35 | −4.52 | −6.78 | −12.65 | −982.81 | −10.48 |
| mv | 120.00 | 80.00 | 119.97 | 125.00 | 136.04 | 145.27 |
| fp | 71.04 | 48.42 | 77.48 | 73.97 | 78.18 | 82.62 |
| fn | −104.35 | −129.50 | −103.93 | −90.98 | −73.06 | −105.75 |
| θ g F1N | 0.55 | 0.55 | 0.55 | 0.55 | 0.55 | 0.55 |
| θ g F1P | 0.54 | 0.53 | 0.54 | 0.54 | 0.54 | 0.54 |
| θ g FvN | 0.55 | 0.55 | 0.54 | 0.55 | 0.54 | 0.54 |
| θ g FvP | 0.58 | 0.59 | 0.58 | 0.60 | 0.58 | 0.58 |
| νd1P | 91.70 | 88.83 | 91.65 | 88.88 | 91.65 | 91.70 |

### Image Pickup Apparatus

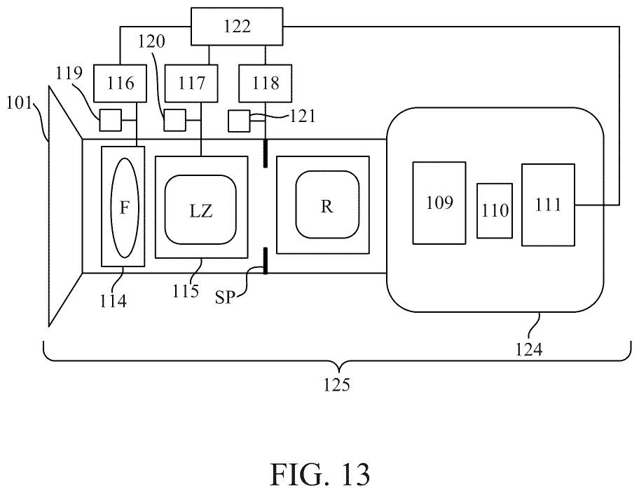

FIG. 13 illustrates an example of the configuration of an image pickup apparatus 125. In FIG. 13, reference numeral 101 denotes a zoom lens according to any one of Examples 1 to 6. Reference numeral 124 denotes a camera body. The zoom lens 101 is attachable to and detachable from the camera body 124. In FIG. 13, the first lens unit L1 is illustrated as a lens unit F, the intermediate group M as a lens unit LZ, and the rear lens unit LR as a lens unit R. SP represents an aperture stop. Reference numerals 114 and 115 are drive mechanisms that drive the lens unit that moves for focusing and the lens unit LZ that moves for zooming, respectively, and include helicoids, cams, etc.

Reference numerals 116 to 118 denote motors (actuators) that drive the driving mechanisms 114 and 115 and the aperture stop SP. Reference numerals 119 to 121 denote detectors that detect positions of the lens unit for focusing and the lens unit LZ and the aperture diameter of the aperture stop SP, and include encoders, potentiometers, photosensors, etc.

In the camera body 124, reference numeral 109 denotes a glass block such as a prism or optical filter. Reference numeral 110 denotes an image sensor as a photoelectric conversion element such as a CCD sensor or CMOS sensor that photoelectrically converts an object image formed by the zoom lens 101 (imaging an object through the zoom lens 101). Reference numerals 111 and 122 denote processing units that perform various processes and controls in the camera body 124 and the zoom lens 101, respectively, and include a processor such as a CPU.

Using the zoom lenses according to Examples 1 to 6 described above can provide the image pickup apparatus 125 having a reduced size and weight and good imaging ability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example according to the disclosure can provide a zoom lens that has a wide angle of view, a high zoom ratio, a reduced size and weight, and high optical performance.

This application claims the benefit of Japanese Patent Application No. 2024-153102, which was filed on Sep. 5, 2024, and which is hereby incorporated by reference herein in its entirety.

What is claimed is:

1. A zoom lens comprising, in order from an object side to an image side:
a first lens unit with positive refractive power that does not move for zooming;
an intermediate group including three or more lens units that move for zooming; and
a rear lens unit with positive refractive power that does not move for zooming,
wherein each distance between adjacent lens units changes during zooming,
wherein the intermediate group includes, in order from the object side to the image side:
a first intermediate negative lens unit that includes a single lens unit or two or more partial lens units and having negative refractive power as a whole that moves monotonically toward the image side during zooming from a wide-angle end to a telephoto end,
a second intermediate negative lens unit having negative refractive power that moves during zooming, and
an intermediate positive lens unit having positive refractive power that moves during zooming, and
wherein at least one of lens units having negative refractive power disposed in the intermediate group moves in a convex locus toward the object side during zooming from the wide-angle end to the telephoto end, and
wherein the following inequalities are satisfied:
$$4. \leq ft / f 1 \leq 8.$$
$$- 9. 0 \leq f 1 / fv \leq - 5.50$$
where fl is a focal length of the first lens unit, fv is a focal length of the first intermediate negative lens unit, and ft is a focal length of the zoom lens at the telephoto end.

2. The zoom lens according to claim 1, wherein the intermediate positive lens unit and the second intermediate negative lens unit are arranged in this order, successively from a lens surface closest to an object in the intermediate group.

3. The zoom lens according to claim 1, wherein the following inequality is satisfied:
$$0.6 \leq ( f 1 + ok 1 ) / f 1 \leq 0.95$$
where ok1 is a distance on an optical axis from a lens surface closest to an image plane of the first lens unit to an image-side principal point of the first lens unit in an in-focus state on the object at infinity.

4. The zoom lens according to claim 1, wherein the following inequality is satisfied:
$$- 0.35 \leq β vw \leq - 0.15$$
where βvw is a lateral magnification of the first intermediate negative lens unit at the wide-angle end.

5. The zoom lens according to claim 1, wherein the following inequality is satisfied:
$$- 1000.00 \leq β vt \leq - 2.00$$
where βvt is a lateral magnification of the first intermediate negative lens unit at the telephoto end.

6. The zoom lens according to claim 1, wherein the following inequality is satisfied:
$$6. \leq ft / \vert mv \vert \leq 15.$$
where mv is a change amount between a position at the wide-angle end and a position at the telephoto end of the single lens unit in the first intermediate negative lens unit, or a change amount between a position at the wide-angle end and a position at the telephoto end a partial lens unit among the two or more partial lens units, which has a largest change amount between the position at the wide-angle end and the position at the telephoto end of the partial lens.

7. The zoom lens according to claim 1, wherein the following inequality is satisfied:
$$1.5 \leq f 1 / fp \leq 5.$$
where fp is a focal length of the intermediate positive lens unit.

8. The zoom lens according to claim 1, wherein the following inequality is satisfied:
$$- 4.00 \leq f 1 / fn \leq - 1.$$
where fn is a focal length of the second intermediate negative lens unit.

9. The zoom lens according to claim 1, wherein the following inequality is satisfied:
$$0. \leq θ gF 1 N - θ gF 1 P \leq 0.030$$
where θgF1P is an average value of partial dispersion ratios for g-line and F-line of all positive lenses included in the first lens unit, and θgF1N is an average value of partial dispersion ratios for the g-line and the F-line of all negative lenses included in the first lens unit.

10. The zoom lens according to claim 1, wherein the following inequality is satisfied:
$$- 0.060 \leq θ gFvN - θ gFvP \leq - 0.020$$
where θgFvP is an average value of partial dispersion ratios for g-line and F-line of all positive lenses included in the first intermediate negative lens unit, and θgFvN is an average value of partial dispersion ratios for the g-line and the F-line of all negative lenses included in the second intermediate negative lens unit.

11. The zoom lens according to claim 1, wherein the following inequality is satisfied:
$$80. \leq vd 1 P \leq 96.$$
where νd1P is an average value of Abbe numbers based on d-line of all positive lenses included in the first lens unit.

12. The zoom lens according to claim 1, wherein during zooming from the wide-angle end to the telephoto end, the intermediate positive lens unit moves to draw a convex trajectory toward the object side and then moves to draw a convex trajectory toward the image side.

13. An image pickup apparatus comprising:
a zoom lens; and
an image sensor configured to image an object through the zoom lens,
wherein the zoom lens includes, in order from an object side to an image side:
a first lens unit with positive refractive power that does not move for zooming,
an intermediate group including three or more lens units that move for zooming, and
a rear lens unit with positive refractive power that does not move for zooming,
wherein each distance between adjacent lens units changes during zooming,
wherein the intermediate group includes, in order from the object side to the image side:
a first intermediate negative lens unit that includes a single lens unit or two or more partial lens units and having negative refractive power as a whole that moves monotonically toward the image side during zooming from a wide-angle end to a telephoto end,
a second intermediate negative lens unit having negative refractive power that moves during zooming, and
an intermediate positive lens unit having positive refractive power that moves during zooming, and
wherein at least one of lens units having negative refractive power disposed in the intermediate group moves in a convex locus toward the object side during zooming from the wide-angle end to the telephoto end, and
wherein the following inequalities are satisfied:
$$4. \leq ft / f 1 \leq 8.$$
$$- 9. 0 \leq f 1 / fv \leq - 5.50$$
where fl is a focal length of the first lens unit, fv is a focal length of the first intermediate negative lens unit, and ft is a focal length of the zoom lens at the telephoto end.
